(19) United States
(12) Patent Application Publication
(10) Pub. No.: US 2005/0009526 A1
(43) Pub. Date: Jan. 13, 2005

(54) Method and apparatus for locating a user having multiple telephone addresses

(76) Inventors: Daniel Sheinbein, Elizabeth, NJ (US); Yves Escaig, Boca Raton, FL (US); Stephen J. Carr, Ocean Ridge, FL (US)

Correspondence Address: Elsa Keller;Siemens Corporation, Intellectual Property Department, 170 Wood Avenue South, Iselin, NJ, 08830, US

(21) Appl. No.: 10/735,797

(22) Filed: Dec. 12, 2003

Related U.S. Application Data
(60) Provisional application No. 60/485,702, filed on Jul. 8, 2003.

(51) Int. Cl. H04Q 7/20

(52) U.S. Cl. 455/445

(57) ABSTRACT

A method and system is disclosed for receiving calls by a network device and determining whether the incoming call is a candidate for being simultaneously or sequentially routed to a plurality of pre-determined destinations. Call legs are originated to the plurality of routed destinations in order to locate an answering station. If any of the simultaneously or sequentially routed stations answers, the call is completed to the first answering station and the other legs are disconnected. This simultaneous or sequential operation is compatible with any type of communication device such as gateways, TDM switches, soft-switches, mobile switches, SIP enabled networks, etc.

### CROSS REFERENCE TO RELATED APPLICATIONS

This application claims the benefit of priority to U.S. Patent Provisional Application Ser. No. 60/485,702 filed on Jul. 8, 2003, the contents of said provisional application being incorporated by reference herein in its entirety.

### BACKGROUND OF THE INVENTION

1. Field of the Invention

The invention generally relates to routing of calls in a communications network to a plurality of destinations, and more particularly, to a system and method where an inbound call causes a plurality of outbound call attempts to reach a subscriber, regardless of type of network.

2. Background Description

Communications infrastructure throughout the world has undergone constant evolution. In fact, much of the world's infrastructure in the public telecommunication domain is comprised of several different technologies and networks. One such technology is public switched telephone networks (PSTN), which are generally utilizing circuit-based-switches. It is common to support PSTN operations with common channel signaling system No. 7 known also as SS7. SS7 is a global standard for telecommunications defined by the International Telecommunications Union (ITU) Telecommunications Standardization Sector (ITU-T).

SS7 signaling supports calls of various natures including wireless (cellular), wireline, data, and a plethora of telephone and data customer features such as credit card validation, voicemail access, paging, banking access, voice conferencing, data connectivity, Internet access, etc. SS7 networks and protocols are typically used for basic call setup, management, and release, local number portability, and toll wireline services. It also supports enhanced call features such as calling party name/number display, three way calling, toll free services, wireless services such as personal communications services (PCS), cellular roaming and mobile subscriber identification.

PSTN circuit-based-switches commonly employ time-division-multiplexing (TDM) techniques to facilitate call connections throughout the network and employ SS7 to facilitate the signaling. TDM has been a common technology and has broad deployment penetrations worldwide. But, the advent of soft-switches which typically utilizes Internet Protocol (IP) technology to unify data and voice switching at very high bandwidth levels provides new capabilities and is a very attractive alternative or complement to ubiquitous circuit-based-switches

Soft-switches are becoming desirable choices for PSTNs as they evolve to an IP network. Softswitches are typically the call processing brains behind distributed networks. Diverse networks may include, for example, one or more TDM switches, IP Networks and mobile switches, etc. These may be deployed in a public network, as part of an enterprise network, or in conjunction with one another.

When a call is received by a user, delivery of the call to a final destination (e.g., a subscriber) may require processing in one or more of these differing types of switching networks, each perhaps employing signaling and control appropriate for the type of technology. However, delivery of the call to an intended subscriber should be independent of the underlying switching or transport mechanism. Unfortunately, the actual location of the user is unknown in today's dynamic environment and may not result in a successful delivery to the subscriber. Uncertainty of the location of the user often limits the ability to provide successful call completion when a subscriber is not present at a primary destination. Often these calls end up in a subscriber's voicemail instead of reaching the subscriber themselves.

Providing a more flexible alternative to reach subscribers, particularly under flexible subscriber control, increases successful call completion attempts. Subscribers that must be reached by a calling party should have the opportunity to have the incoming call presented at more than one location as determined by the subscriber.

### SUMMARY OF THE INVENTION

An aspect of the invention includes a method of processing calls. The method includes the steps of receiving a call that specifies a destination address, checking whether simultaneous and/or sequential routing is active, and if active, accessing a list listing a plurality of destinations, and originating call legs for destinations in the list according to the results of the checking step.

Another aspect of the invention comprises a system for processing calls. The system includes a means for receiving a call that specifies a destination address, a means for checking whether simultaneous or sequential routing is active, and if active, accessing a list listing a plurality of destinations. A means for originating call legs for destinations in the list is provided according to the results of the checking step.

A computer program product comprising a computer usable medium having readable program code embodied in the medium. The product comprises a first software component to receive a call that specifies a destination address, a second software component to check whether at least one of simultaneous and/or sequential routing is active, and if active, accessing a list listing a plurality of destinations. A third software component to originate call legs for destinations in the list is provided according to the results of the checking step.

### BRIEF DESCRIPTION OF THE DRAWINGS

FIG. 1 is a diagram of an embodiment of the invention;

FIG. 2 is an embodiment of the invention showing a SS7 network interaction involving the public network, gateway, and soft switch with a corporate connect server, according to the invention;

FIG. 3 is an exemplary graphical user interface for use in administering the invention; and

FIGS. 4A-4B are flow diagrams showing steps of using the invention.

### DETAILED DESCRIPTION OF A DETAILED EMBODIMENT OF THE INVENTION

The invention relates to call routing and connections of calls in a plurality of communications networks and a plurality of potential destinations. In particular, the invention provides a system and method of simultaneously or sequentially connecting an incoming call to a plurality of possible destinations in order to present the incoming call to a subscriber who may be at any of the plurality of destinations. In the system and method of the invention, the simultaneous operation is compatible with any type of communication device. This allows added flexibility to the system and method of the invention.

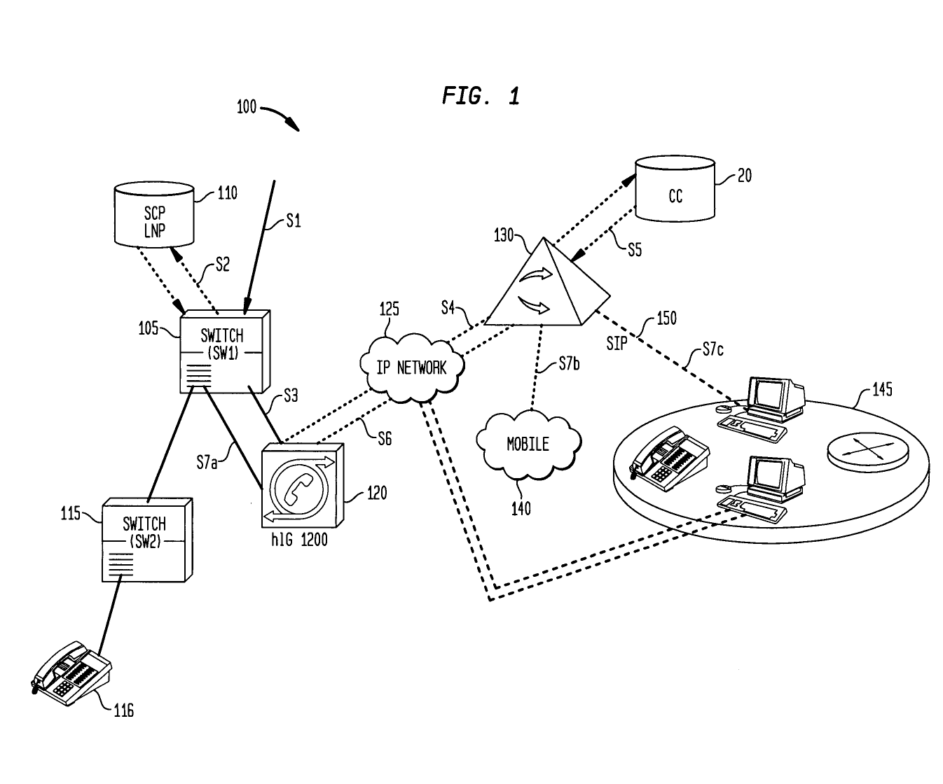

FIG. 1 is a diagram of an embodiment of the invention, generally denoted by reference numeral 100. This embodiment may include elements, for example:

(i) network switch 105 (e.g., a class 5 switch) which may represent a type of switch in the public network 40,

(ii) a service control point (SCP) 110 that may provide local number portability (LNP), and

(iii) switch 115 (which may be a TDM switch, such as another class 5 switch or similar switch). One or more telephone devices 116 may be associated with the switch 115.

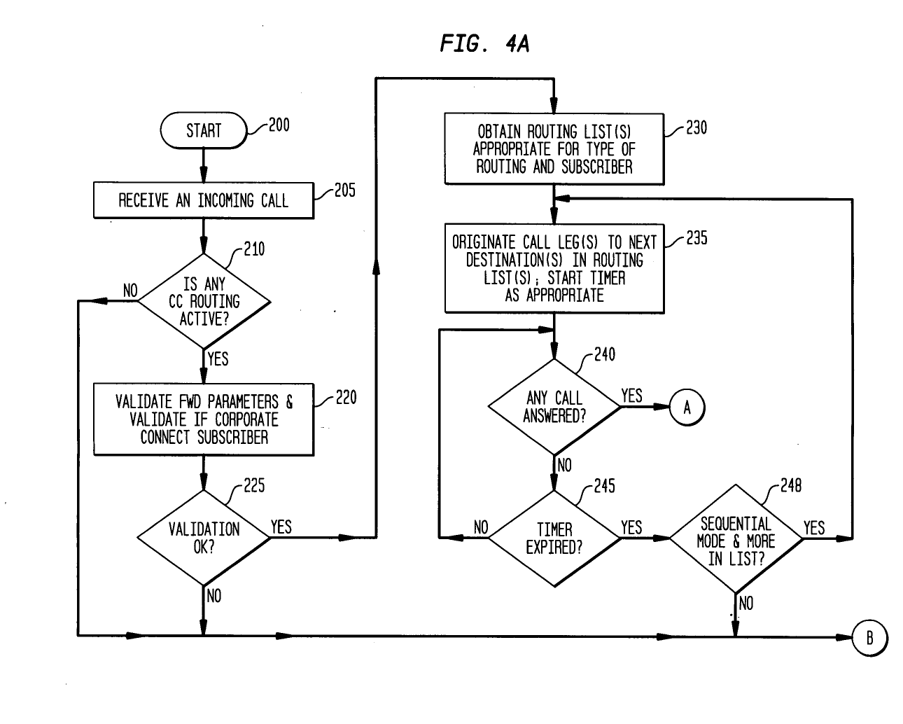

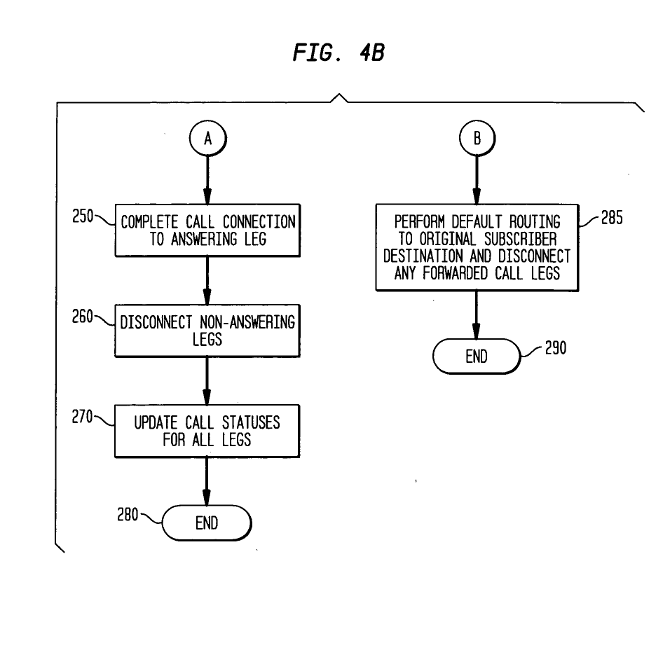

The embodiment of FIG. 1 may also include as part of the IP network, a gateway 120 for interfacing to and from the IP network 125 and a soft switch 130 for providing control of voice and data traffic and features in the IP environment. The IP network may also include, for example, a corporate connect server 20 for providing a routing database according to the invention as explained below. Also provided is a network of mobile users 140 for wireless devices, and one or more SIP devices 145 that may include various types of SIP enabled instruments, such as, for example, IP phones, personal computers, wireless voice and data instruments, and the like. The SIP devices use SIP 150, but one of ordinary skill in the art would recognize that other suitable control protocols may be used. FIG. 1 also shows steps (e.g., S1,-S7c) of routing a call described below in relation to FIGS. 4A and 4B.

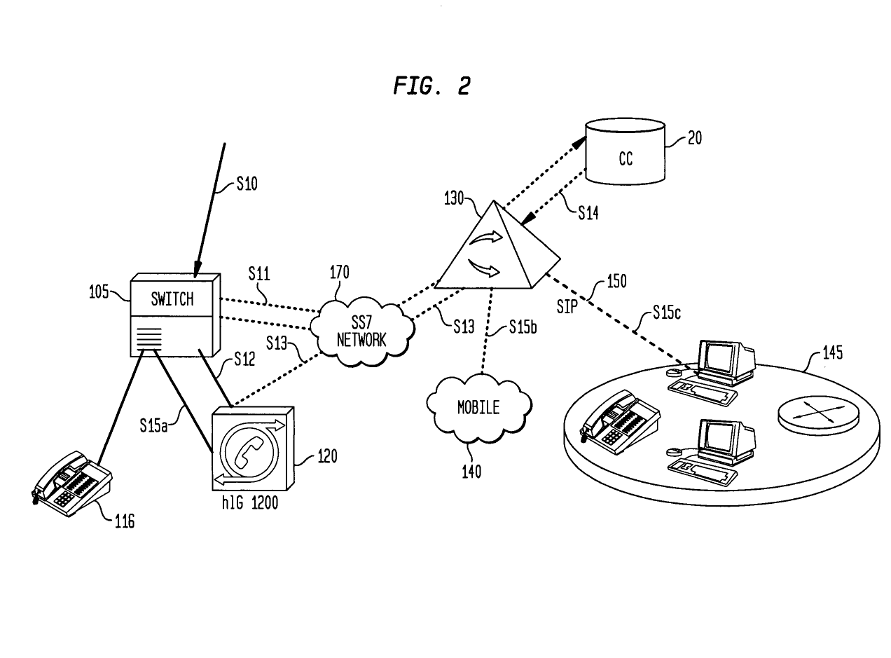

FIG. 2 is an embodiment of the invention showing a SS7 network 170 interaction involving gateway 120, and soft switch 130 with corporate connect server 20 functionality. The embodiment of FIG. 2 may also include a mobile network 140 and an IP network 145, perhaps interconnected to the soft switch 130 using SIP. This interaction is described below, with reference to tables 1 and 2, also discussed below.

FIG. 2 also shows steps of processing a call and the interconnectivity of the network devices. References S10 through S15c represent steps of processing a call and also represent interface interconnectivity between corresponding devices. For example, reference S10 may be a T1 interface, or the like, interconnecting the switch 105 with a public network for delivering the call. S10 also represents a step in the process of the invention. Reference S11 represents a step in the call processing sequence and also represents the control and bearer interface(s) between the switch 105 and SS7 network 170. Reference S12 represents a control and bearer interface(s) between switch 105 and gateway 120 (e.g., an IP interface) and also represents a step in the processing of the call. Similarly, references S13 through S15c represent appropriate control and bearer interfaces between corresponding network devices and also represent steps in the sequence of call processing.

Still referring to FIG. 2, the corporate connect server 20 provides for routing information for a subscriber number. By way of example, Table 1 provides information that may be included in a routing table of the corporate connect server 20. It should be understood that Table 1 below is provided for illustrative purposes and the example provided in Table 1 is not to be considered a limiting feature of the invention.

TABLE 1

| SUBSCRIBER | TYPE OF ROUTING | DESTINATION LIST |
|---|---|---|
| 3141 | 9-5 PM | List 1 |
| | 5 PM until 12 PM | List 2 |
| | 12 PM until 9 AM | List 3 |
| 3150 | All hours | List 4 |

Referring to Table 1, the first column identifies a SUBSCRIBER (e.g., 3141 and 3150) and may be any number or identifier that renders an association with a subscriber, such as, for example, a telephone directory number, an IP address, a user ID, or the like. Column 2 defines the TYPE OF Routing and column 3 defines the associated list(s) to be accessed to simultaneously initiate routing of an incoming call. In embodiments, another parameter may indicate which types of routing are currently active on a subscriber, such as, for example, whether simultaneous or sequential routing (or a combination) is desired. Sequential routing attempts to locate a subscriber by sequentially attempting routing to each entry in the list in turn. Alternatively, portions of the list may reflect sequential routing and a portion may reflect simultaneous routing, administrable by the user, so that both sequential and simultaneous routing may occur.

The incoming call is then simultaneously (and/or sequentially) routed to all destinations of List 4 until an answer is received. If no answer is received in a pre-determined time period, default processing occurs for the originally dialed number (or identifier), in this example, 3150.

Table 2, shown below, provides an example of the information, in list form, to define the route-to destinations that are simultaneously (or sequentially) routed for the given subscriber when the feature of the invention is activated. The lists of Table 2 may also include the original subscriber number so that the original subscriber destination is also presented with the incoming call simultaneously. It should be understood that Table 2 is provided for illustrative purposes and the example provided in Table 2 is not to be considered a limiting feature of the invention. As with Table 1, it should be understood that these tables may be one or several tables and sized according to the amount of subscribers and destinations. Also, the entries may contain more parameters to provide more flexibility to the users such as, for example, one or more time of day and day of week filters for when a particular type of routing (e.g., sequential or simultaneous) may be activated. Routing may also be dependent on the calling party's identification (e.g., caller id), i.e., routing may only occur (or conversely, not occur) depending on the identity of the calling party associated with the incoming call.

TABLE 2

| | |
|---|---|
| List 1 | 412-555-1213 |
| | 412-555-1215 |
| | IP address #1 |
| | User ID #1 |
| List 2 | 412-555-1255 |
| | 412-555-1256 |
| | 419-555-1234 |
| | User ID #2 |
| List 3 | IP address #2 |
| | 419-555-2222 |
| List 4 | 212-555-1234 |
| | 312-555-1236 |

Referring to Table 2, one or more data structures may be provided to define the routed destinations. In this example of Table 2, four lists are defined and each list may specify destinations as one or more telephone numbers, IP addresses, user ID's, or similar designations. If an incoming call meets the criteria established by a subscriber per Table 1, the appropriate list is accessed and calls are simultaneously (or sequentially, as appropriate) originated to each destination specified in the list (e.g., List 1-List 4) in an attempt to reach a destination that answers the routed call. As soon as any one of the routed destinations answers the call, all other simultaneously routed (if applicable) calls are immediately disconnected. If no answer is forthcoming from any simultaneously routed call, then default routing for the original subscriber's number is processed which often includes voicemail answering and processing.

Now, referring again to FIG. 1, an illustrative example of the operation and steps of the invention is shown beginning with an incoming call to switch 105 (S1). At S2, the switch 105 may perform an LNP dip to acquire any new ported number, if available. At S3, switch 105 routes the call to gateway 120 as determined by routing data in the Local Number Portability Data Base. At S4, the gateway signals the soft-switch 130 for processing of the incoming call. The soft-switch 130 determines that the addressed subscriber is marked as a corporate connect (CC). At S5, the Corporate Connect server 20 checks the routing parameters of Table 1 and obtains a list (e.g., Lists 1-4 of Table 2) appropriate for the subscriber. In embodiments, both Table 1 and 2 may be maintained and processed by the corporate connect server 20.

Once the soft-switch 130 acquires the appropriate list, at S6, the soft-switch commands the gateway 120 to originate and establish a call leg to all numbers or destinations in the routing list (e.g., Lists 1-4 of Table 2) and may include the original subscriber identifier (e.g., original directory number dialed) as one of the destinations. At S7a, S7b, S7c, the gateway simultaneously (or sequentially, as appropriate) originates calls to various destinations as indicated by the routing list, honoring the protocols and control structure according to the type of destination involved for each destination (e.g., SIP station, wireless phone, TDM, etc.). On the first answer, the gateway completes the call to the first-to-answer subscriber and disconnects any other legs and may inform the soft-switch of the new status of the completed call and released call legs.

Referring again to FIG. 2, another illustrative example of the operation and steps of the invention is shown also to illustrate examples of Table 1 and Table 2. At S10, an incoming call to switch 105 (e.g., class 5) is processed (using destination subscriber identifier, such as dialed number) and, at S11, a terminating attempt Advanced Intelligent Network (AIN) trigger may occur as part of the SS7 network function. At S12, switch 105 routes the call to gateway 120 and, at S13, the gateway contacts the soft-switch 130. The soft-switch 130 determines that the destination subscriber is marked as corporate connect and, at S14, contacts the corporate connect server 20 which checks parameters (e.g., Table 1) to obtain an appropriate list (e.g., Lists 1-4 of Table 2). The soft-switch commands the gateway to simultaneously originate (and/or sequentially originate) a call leg to all numbers or destinations in the list (e.g., Lists 1-4 of Table 2) and may include the original subscriber identifier (e.g., original directory number dialed). If sequential routing is being performed and if a currently routed call is answered, sequential routing processing terminates. If however, the currently routed sequential call does not answer by a predetermined ring count (or timing period) the next sequential destination in the list (e.g., Lists 1-4 of Table 2) is the attempted.

At S15a, S15b, S15c, the gateway simultaneously originates calls to various destinations as indicated by the appropriate list and the calls may traverse one or more network devices as necessary (S15a, S15b, S15c as shown reflect a portion of the total call legs established by the gateway). For example, S15a represents a call leg from the gateway 120 to the switch 105 (perhaps targeting telephone 116, for example) while S15b represents a call leg originating from the gateway 120 through the SS7 network 170 to the soft switch 130 to the mobile network 140 to a mobile station (e.g., personal digital assistant (PDA) or mobile phone). Likewise, S15c represents the call leg through the SS7 network 170 to the soft switch 130, onward to the enterprise network 145 to a station within the enterprise network.

As shown, the originated calls progress through the networks honoring the protocols and control structure along the route and according to the type of destination involved for each routed destination (e.g., SIP station, wireless phone, SS7, TDM, etc.). On the first answer, the gateway completes the call to the first-to-answer subscriber and disconnects the other legs and may inform the soft-switch of the new status of the completed call and disconnected calls.

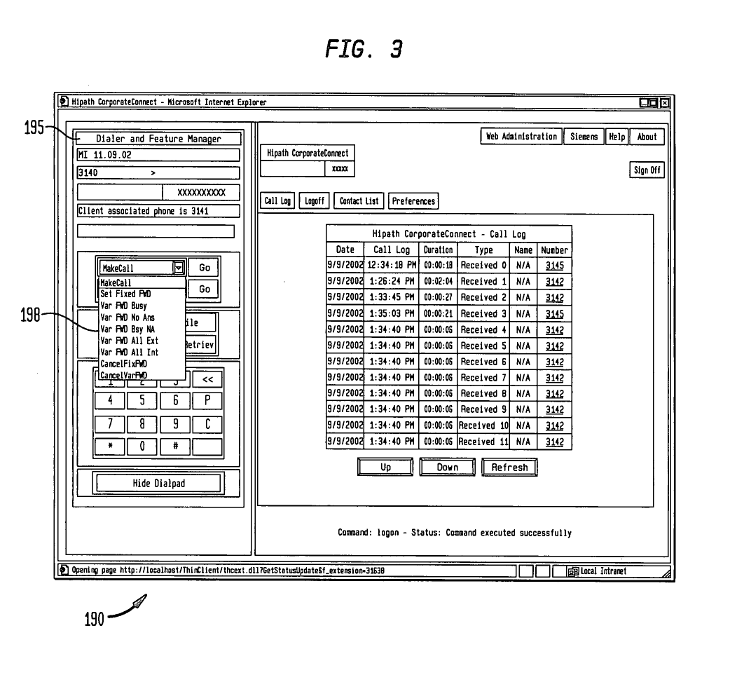

FIG. 3 is an exemplary graphical user interface for use in administering the invention. Referring to FIGS. 1 and 3, the corporate connect server's 20 database may be administered, at least in part, by a graphical user interface (GUI), generally denoted by reference numeral 190. A Dialer and Feature Manager 195 may be selected by a user/subscriber, or alternatively, an administrator to choose the type of routing to be activated for the user/subscriber from a routing list 198, in this example, for user/subscriber extension 3141, although any associated user/subscriber identifier may be employed (e.g., directory number, user ID, or IP address). One or more types of routing may be invoked as desired by a subscriber as well as other parameters of Table 1 via the GUI. One or more predefined lists of destinations may become active for the invoked types of routing. In embodiments, the Dialer and Feature Manager 195 may also be used to build and maintain the routing lists of Table 2.

FIGS. 4A and 4B are flow charts showing steps of an embodiment for using the invention starting at step 200. FIGS. 4A and 4B may equally represent a high-level block diagram of components of the invention implementing the steps thereof. The steps of FIGS. 4A and 4B may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM).

At step 205, an incoming call is detected and received which bears a subscriber's address (e.g., a directory number, IP address, or User ID, or the like) indicating an intended destination of the call. At step 210, a check is made whether any routing is active and if not, processing continues at step 285. If corporate connect is active, at step 220, a validation is made on the parameters of the routing (e.g., type of routing conditions met, time of day, day of week, caller id, etc.). At step 225, a check is made whether the validation of parameters confirms routing, e.g., at least one type of routing (e.g., sequential and/or simultaneous routing) is requested. If the validation does not confirm routing validity (e.g., not correct time period or caller id indicates a caller not supporting corporate connect routing) at step 285, default routing is performed for the original called subscriber routing to voice mail, or the like. The process terminates then at step 290.

However, if the validation is OK, then, at step 230, one or more routing lists are obtained according to the type(s) of routing that is active for the called subscriber. At step 235, calls are simultaneously originated (and/or sequentially originated) for all destinations in the list(s). A predetermined call timer is may be selected and started appropriate to the combined types of calls being initiated (i.e., some types of calls may require longer timer durations due to differing set-up times, e.g., wireless), typically in the range of 15-40 seconds, although not limited to this range. Alternatively, a “number of rings” parameter may be selected to act as the timing mechanism to count rings.

At step 240, a check is made whether any of the simultaneously (or sequentially as appropriate) called destinations has answered. If so, then processing continues at step 250. If there is no answer, then at step 245, a check is made whether the timer (or, alternatively, ring count) has expired. If it has not expired, the processing continues at step 240. But if the timer has expired, indicating that no routed destination has answered in the pre-determined time period, then at step 248, a check is made if this is sequential processing and another entry remains in the list. If so, then processing continues at step 235, otherwise, at step 235, default process occurs for the originally dialed station.

In embodiments, the originally dialed station may be automatically included as one of the destinations even if the original station does not appear in a routing list. This may mean that the original called subscriber has already been alerting (e.g., ringing) during the period of the simultaneously routed attempts. At step 285, since no routed-to destination has answered (or no routing and call connect is active), any unanswered call legs are disconnected and default routing is performed for the originally called subscriber (e.g., voicemail, or the like). The process ends at 290.

If, however, at step 240, one of the simultaneously routed (or sequentially routed) call legs is answered, a completed call connection is made to the answering leg, at step 250, so that an end-to-end path is completed between the originator and the destination party. At step 260, all other non-answering (at least not the first to answer) call legs are disconnected. At step 270, call statuses are updated for all call attempts and completions. The process ends at step 280.

While the invention has been described in terms of embodiments, those skilled in the art will recognize that the invention can be practiced with modifications and in the spirit and scope of the appended claims.

1. A method of processing calls comprising the steps of:
receiving a call that specifies a destination address;
checking whether at least one of simultaneous and sequential routing is active, and if active, accessing a list listing a plurality of destinations; and
originating call legs for destinations in the list according to the results of the checking step.

2. The method of claim 1, wherein the originating step simultaneously originates a plurality of call legs when the checking step determines that simultaneous routing is active.

3. The method of claim 1, wherein the originating step sequentially originates a plurality of call legs when the checking step determines that sequential routing is active.

4. The method as recited in claim 3, when the step of checking routing parameters includes at least one of time of day, day of week, and calling party identity.

5. The method as recited in claim 1, further comprising starting a timer for timing duration of the originated call legs.

6. The method as recited in claim 1, further comprising checking a timer for expiration, and if expired, disconnecting any originated call legs.

7. The method as recited in claim 6, comprising routing the received call to the destination address using default processing.

8. The method as recited in claim 1, further comprising detecting an answer by one of originated legs and completing a call connection.

9. The method as recited in claim 1, further comprising updating call statuses when one of the call legs is answered.

10. The method as recited by claim 1, wherein in any step, the any step is performed by at least one of a time division multiplex (TDM) switch, a soft-switch, and a gateway.

11. The method recited in claim 1, wherein the list is administrable by a graphical user interface.

12. The method of claim 1, wherein the originating step originates a combination of simultaneously originated call legs and sequentially originated call legs as determined by the checking step.

13. A system for processing calls, the system comprising:
a means for receiving a call that specifies a destination address;
a means for checking whether at least one of simultaneous and sequential routing is active, and if active, accessing a list listing a plurality of destinations; and
a means for originating call legs for destinations in the list according to the results of the checking step.

14. The method of claim 13, wherein the means for originating call legs simultaneously originates a plurality of call legs if the checking step determines that simultaneous routing is active and sequentially originates a plurality of calls if the checking step determines that sequential routing is active.

15. The system as recited in claim 13, wherein the means for checking provides for checking parameters that include at least one of time of day, day of week, and calling party identity, the parameters controlling conditions when the originating step occurs.

16. The system as recited in claim 13, further comprising a means for starting a timer for timing duration of the simultaneously originated call legs.

17. The system as recited in claim 16, further comprising a means for checking the timer for expiration, and if expired, abandoning the simultaneously originated call legs.

18. The system as recited in claim 13, further comprising a means for routing the received call to the destination address using default processing.

19. The system as recited in claim 13, further comprising a means for detecting an answer by an originated call leg and completing a call connection.

20. The system as recited in claim 13, further comprising a means for updating call statuses when one of the call legs is answered.

21. The system as recited by claim 13, wherein the means for originating is one of a gateway and a soft-switch.

22. The system as recited in claim 13, wherein the list is administrable by a graphical user interface.

23. The system as recited by claim 13, wherein at least one of the originated call legs are process by at least one of a time division multiplex (TDM) switch, a soft-switch, and a gateway.

24. The system of claim 13, wherein the means for originating call legs originates a combination of simultaneously originated call legs and sequentially originated call legs.

25. A computer program product comprising a computer usable medium having readable program code embodied in the medium, the computer program product includes:
a first software component to receive a call that specifies a destination address;
a second software component to check whether at least one of simultaneous and sequential routing is active, and if active, accessing a list listing a plurality of destinations; and
a third software component to originate call legs for destinations in the list according to the results of the checking step.
